(19) United States
(12) Patent Application Publication
(10) Pub. No.: US 2022/0067640 A1
(43) Pub. Date: Mar. 3, 2022

(54) A METHOD FOR CONTROLLING A MANAGEMENT SYSTEM AND RELATED ELECTRONIC DEVICE

(71) Applicant: Sony Group Corporation, Tokyo (JP)

(72) Inventors: Lijo GEORGE, Lund (SE); Louis JANSEVANRENSBURG, Lund (SE); Johan OXENSTIERNA, Lund (SE)

(21) Appl. No.: 17/416,478

(22) PCT Filed: Dec. 3, 2019
(86) PCT No.: PCT/SE2019/051225

§ 371 Date: Jun. 19, 2021

(30) Foreign Application Priority Data
Dec. 20, 2018 (SE) 1851623-7

(51) Int. Cl. G06Q 10/08; G01C 21/00; G06Q 50/28

(52) U.S. Cl. CPC G06Q 10/087; G06Q 50/28; G01C 21/383

(57) ABSTRACT

The present disclosure provides a method, performed in an electronic device, for controlling a management system configured to manage items stored in a storage facility. The method comprises obtaining a first data set. The first data set is indicative of at least one item of the items stored in the storage facility. The first data set comprises a first location code associated with a first item. The method comprises obtaining a second data set. The second data set is indicative of at least one geometric object associated with a layout element of the storage facility. The method comprises generating, based on the first data set and the second data set, a spatial location data set indicative of spatial location of the at least one item and the at least one geometric object. The spatial location data set comprises a first spatial location of the first item in a spatial reference system.

The present disclosure pertains to the field of storage facility or warehouse management. More particularly, the present disclosure relates to a method for controlling a management system and related electronic device.

### BACKGROUND

Management systems of storage facilities (e.g. Warehouse Management Systems, WMS), help warehouse managers control warehouse efficiency and throughput. WMSs process incoming orders and schedule work tasks related to i) sorting incoming goods for temporary storage, ii) pick runs: picker workers collection or ‘picking’ of stored goods for fulfillment of orders placed by customers, iii) picker machine collection or ‘picking’ of stored goods for fulfillment of orders placed by customers, iv) packaging collected goods in final preparation for outbound transportation.

It is seen that warehouses or storage facilities are environments where there is substantial complexity which leads to difficult control problems that require solving in order to increase efficiency and to enable efficient picking tasks.

### SUMMARY

Accordingly, there is a need for electronic devices and methods which attempt to overcome, alleviate or address challenges described above and lead to an improved picking process, such as provision of improved (e.g. optimized, e.g. optimal) pick sequence for a picker or a group of pickers.

The present disclosure provides a method, performed at an electronic device, for controlling a management system configured to manage items stored in a storage facility.

The method comprises obtaining a first data set. The first data set is indicative of at least one item of the items stored in the storage facility. The first data set comprises a first location code associated with a first item. The method comprises obtaining a second data set. The second data set is indicative of at least one geometric object associated with a layout element of the storage facility. The method comprises generating, based on the first data set and the second data set, a spatial location data set indicative of spatial location of the at least one item and the at least one geometric object. The spatial location data set comprises a first spatial location of the first item in a spatial reference system. The method comprises generating, based on the spatial location data set, a graphical network comprising a set of nodes and a set of edges. The set of nodes comprises a first node associated with the first item and a depot node. The method comprises obtaining a picking list comprising the first item and the first location code. The method comprises determining a route based on the graphical network and the picking list. The method comprises providing a pick sequence based on the determined route.

Further, an electronic device is provided, the device comprising: a memory module, an interface module, and a processor module, wherein the electronic device is configured to perform any of methods as disclosed herein.

Further, a system is provided, the system comprising: an electronic device disclosed herein, and a client device. The system is configured to perform any of the methods disclosed herein.

Further, the present disclosure provides a computer readable storage medium storing one or more programs, the one or more programs comprising instructions, which when executed by an electronic device with an interface, a memory module, and a processor module cause the electronic device to perform any of the methods disclosed herein. It is an advantage of the present disclosure that the distance travelled by pickers for picking goods is reduced. For example, the inventors have shown to achieve a reduction of 15% comparing the presently disclosed technique to historical distance travelled by pickers in an exemplary storage facility or warehouse, (given a 2 months log data set). This may lead to an optimization of a storage facility or warehouse throughput capacity and may result in efficiency gains for the warehousing operator.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary representation of an exemplary graphical network, an exemplary first data set and an exemplary second data set according to this disclosure,

FIG. 2 is illustrating an exemplary system comprising an exemplary WMS system, and an exemplary electronic device according to this disclosure,

FIGS. 3A-3B are flow-charts illustrating an exemplary method, performed at an electronic device for controlling a management system and related electronic device according to this disclosure,

FIG. 4 is a block diagram illustrating an exemplary electronic device according to this disclosure,

FIG. 5 is a diagram illustrating an exemplary disallowing operation according to this disclosure,

FIG. 6 is a diagram illustrating an exemplary spatial location data set, an exemplary adjacency matrix, an exemplary weighted adjacency matrix, an exemplary representation of an exemplary graphical network, an exemplary shortest path dictionary, and an exemplary shortest path distance matrix according to this disclosure, and

FIG. 7 illustrates in graphical representations an exemplary picking list, an exemplary first data set, an exemplary shortest path distance matrix, and an exemplary subset-shortest path distance matrix according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

In warehouses or storage facilities, generating pick sequences (for e.g. pick runs) for warehouse workers (e.g. pickers) is a challenge. Pick sequences are generated to direct the pickers to items which are to be collected (e.g. intended for outbound transportation) and which are stored at different locations in the warehouse or storage facility. The number of possible ways to route a pick run is factorial in the number of items (with distinct locations) that need to be collected. For example, a seemingly small problem where 20 items (with distinct locations) need to be collected on a given pick run, has 20! (or 2.43*10\hat{ }18) possible ways to route the pick run. In order to optimize pick run efficiency, the present disclosure proposes in one or more embodiments to determine a pick sequence (e.g. the route) that ensures a picker travels a minimal amount of distance necessary (hence saving time and resources that would otherwise be used unnecessarily).

The figures are schematic and simplified for clarity, and they merely show details which are essential to the understanding of the invention, while other details have been left out. Throughout, the same reference numerals are used for identical or corresponding parts.

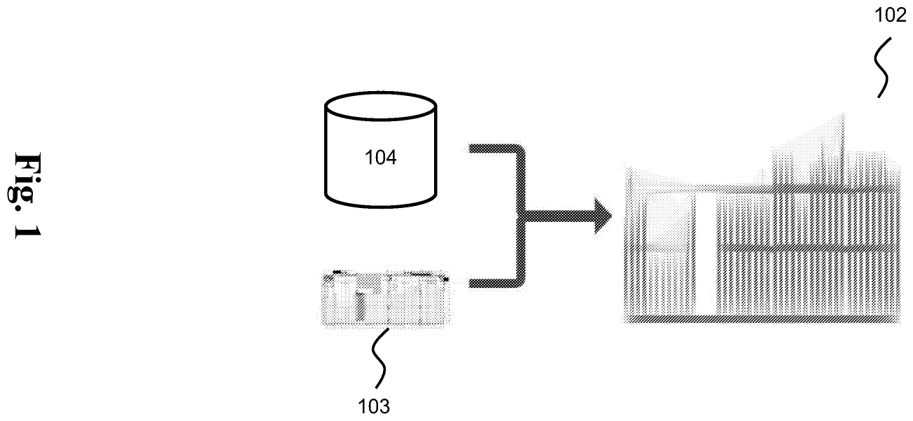

FIG. 1 is diagram illustrating an exemplary representation 102 of an exemplary graphical network, an exemplary first data set 104 and an exemplary second data set 103 according to this disclosure.

The first data set 104 is indicative of at least one item of the items stored in the storage facility. For example, the items stored in the warehouse comprise at least one item, such as a first item. For example, the items stored in the storage facility comprise a first item, a second item, and optionally a third item. For example, the first data set 104 comprises a first location code associated with a first item. In one or more exemplary methods, the first data set 104 comprises data varying in time, such as log data indicative of one or more pick runs. In one or more exemplary methods, the first data set 104 may comprise a log data set (e.g. a set of log entries). In one or more exemplary methods, the first location code may comprise location information codified uniquely to be associated with a physical location where an item may be stored. In one or more exemplary methods, a location code may relate to a logical location of an object in a logical data structure.

The second data set 103 may be indicative of at least one geometric object associated with a layout element of the storage facility. In one or more exemplary methods, a layout element may relate to the layout of the storage facility. The layout characterizes a structure and/or one or more architectural elements of the warehouse or storage facility (e.g. floor structure) and a dimension thereof. In one or more exemplary methods, a second data set 103 may comprise data indicative of a rack, data indicative of one or more walls, data indicative of one or more machinery-zones and data indicative of one or more office rooms. In one or more exemplary methods, a second data set 103 may comprise one or more polygonal shapefiles associated with a warehouse structure, and/or one or more label associated with a rack and/or a rack identifier.

The present disclosure provides in one or more embodiments a generating of the graphical network represented by representation 102 based on the first data set 104 and the second data set 103 in that the first data set 104 and the second data set 103 are used to generate a spatial location data set associated with one or more items, which is in turn used to generate the graphical network.

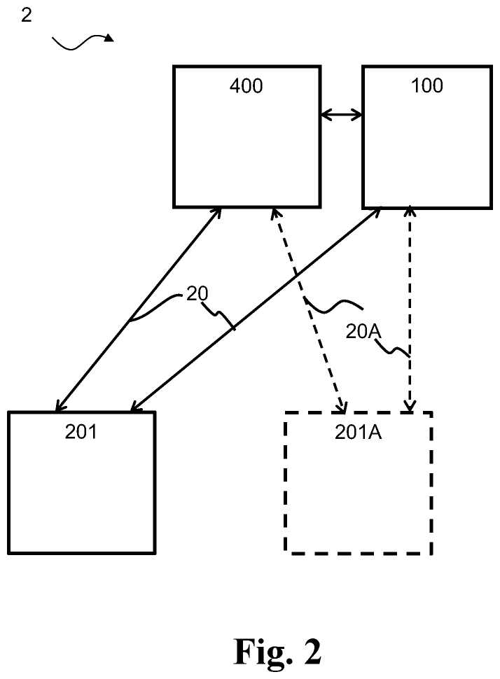

FIG. 2 shows an exemplary system 2 comprising an exemplary warehouse management system, WMS, 100, and an exemplary electronic device 400 according to this disclosure.

The electronic device 400 is configured to perform the methods disclosed herein. The electronic device 400 may be a server device configured to communicate with the WMS 100 and optionally with one or more client devices (e.g. picker devices 200, 201). The electronic device 400 may be a cloud-based server device and/or a network node.

A warehouse management system, WMS, may comprise a software application, designed to support and optimize warehouse functionality and distribution center management. A WMS system is configured to control utilization of available resources, to move and/or to store items into, within, and/or out of a warehouse.

A warehouse may comprise a storage facility.

The present disclosure may be seen as applicable to control of storage management systems, control of navigation in a storage facility.

The system may comprise one or more picker devices 201 and 201A configured to communicate with any of the WMS 100 and the electronic device 400 via communication links (e.g. wireless links) 20, 20A. A picker device may be seen as a client device. A client device may refer to a mobile device and/or a tablet, and/or a portable electronic device. A client device disclosed herein may comprise a portable electronic device (e.g. a mobile phone, a smart phone, a tablet) and/or a client device embedded in a vehicle which is adapted to pick goods.

The present disclosure provides a client device comprising a memory module, an interface and a processor module, wherein the client device is configured to provide, e.g. transmit, a picking list to the electronic device 400 or to the WMS 100 and to obtain, e.g. receive, a pick sequence from the electronic device 400 or the WMS.

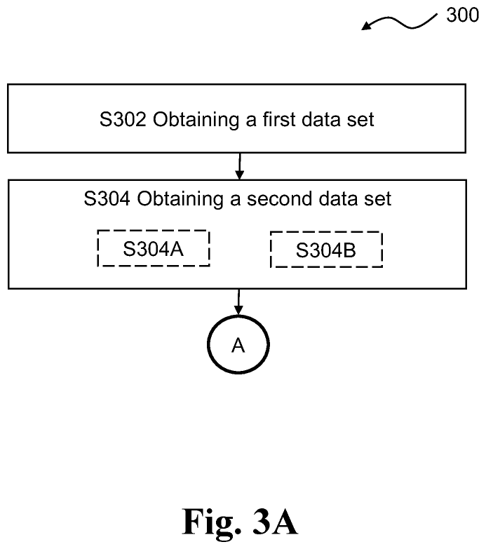

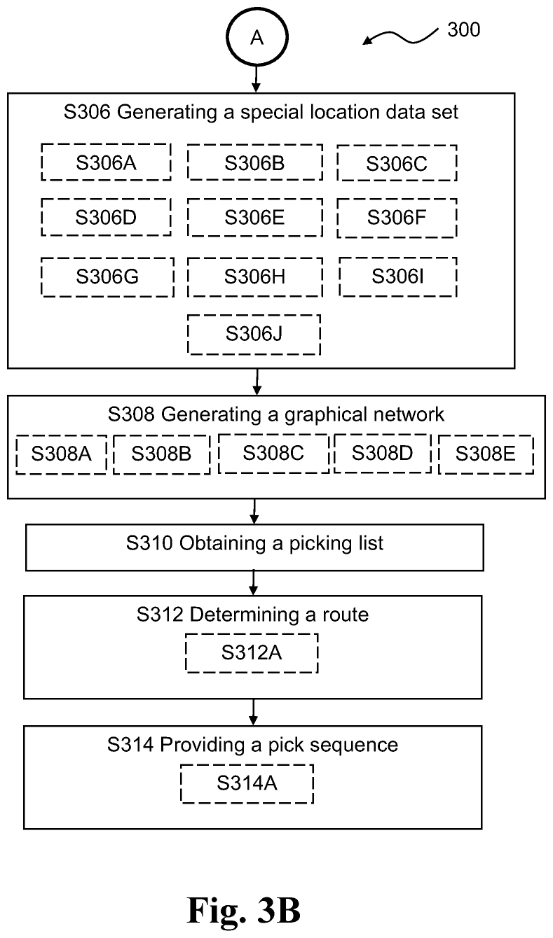

In one or more exemplary aspects of this disclosure, the client device may be configured to perform any of the steps of the methods disclosed herein (e.g. any of the steps of method 300 of FIGS. 3A-3B). In other words, the electronic device is a client device in one or more embodiments.

In one or more exemplary aspects of this disclosure, the system, comprising the electronic device and the client device, may be configured to perform any of the steps of the methods disclosed herein (e.g. any of the steps of method 300 of FIGS. 3A-3B).

In one or more exemplary aspects of this disclosure, the WMS system comprises the electronic device disclosed herein.

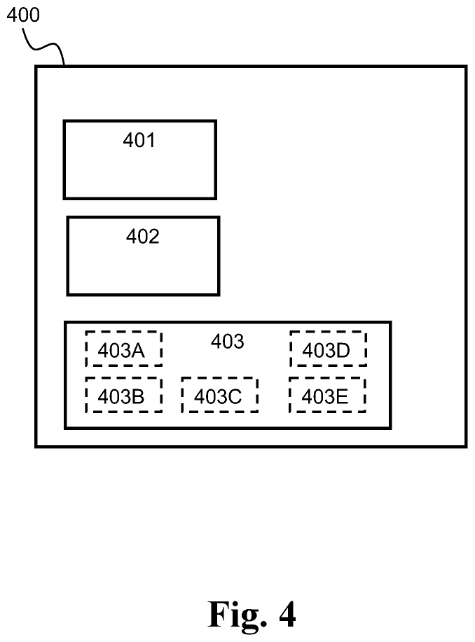

FIGS. 3A-3B show flow diagrams of an exemplary method 300 performed at an electronic device (e.g. electronic device 400 of FIG. 2 and FIG. 4) for controlling a management system configured to manage items stored in a storage facility. For example, the method 300 may be performed for controlling a warehouse management system configured to manage items stored in a warehouse, e.g. configured to assign and/or control pick sequence(s). The term “warehouse” and “storage facility” may be used interchangeably in the present disclosure. A controlling a management system configured to manage items stored in a storage facility may refer to a warehouse management system.

The method 300 comprises obtaining S302 a first data set, e.g. from the warehouse management system. The first data set is indicative of at least one item of the items stored in the storage facility (e.g. warehouse). For example, the items stored in the storage facility comprise at least one item, such as a first item. For example, the items stored in the storage facility comprise a first item, a second item, and optionally a third item. For example, the first data set comprises a first location code associated with a first item. Obtaining S302 a first data set (e.g. from the management system or the warehouse management system) may comprise receiving and/or retrieving the first data set from the management system or the warehouse management system.

In one or more exemplary methods, the first data set comprises data varying in time, such as log data indicative of one or more pick runs. In one or more exemplary methods, the first data set may comprise a log data set (e.g. a set of log entries). In one or more exemplary methods, the first location code may comprise location information codified uniquely to be associated with a physical location where an item may be stored. In one or more exemplary methods, a location code may relate to a logical location of an object in a logical data structure.

For example, the first location code associated with the first item may comprise one or more of a first operational code associated with the first item, a first handling material identifier associated with the first item (e.g. a first Material Handling Area' (MHA) ID), a first rack identifier associated with the first item (e.g. a first Rack ID), a first horizontal rack location identifier associated with the first item (e.g. a first Horizontal Rack Location ID), a first vertical rack location identifier associated with the first item (e.g. a first Vertical Rack Location ID).

In one or more exemplary methods, the first data set may comprise a second location code associated with a second item. For example, the second location code associated with the second item may comprise one or more of a second operational code associated with the second item, a second handling material identifier associated with the second item, a second rack identifier associated with the second item, a second horizontal rack location identifier associated with the first item, a second vertical rack location identifier associated with the second item. In one or more exemplary methods, the first data set may comprise a Nth location code associated with a Nth item, where N is an integer.

In one or more exemplary methods, the operational code denotes a type of event that occurred associate with an item, e.g. for a given log entry. For example, the first data set may comprise an operational code (e.g. an operational code value) corresponding to a ‘pick event’. For example, it may be envisaged that the operational code for the ‘pick event’ is an input parameter provided by the WMS. The first data set (e.g. log data set) may be in the form of tabular data (rows as entries, columns as attributes). In other words, for example, log entries (rows in the first data set) include operational code values corresponding to a ‘pick event’ of an item. For example, columns of the log data set may refer to attributes of a given log entry (such as, a time-stamp of the log entry or a codified operation-type that was performed). It is to be noted that there may be many (100+) columns in a log data set and hundreds of millions of log entries that have been logged, for instance, over a two-months period, depending on the size of the storage facility or warehouse.

In one or more exemplary methods, the rack identifier denotes a numerical value corresponding to the rack in the storage facility or warehouse where the pick was made.

In one or more exemplary methods, the horizontal rack identifier denotes a numerical value specifying where (e.g. length-wise) along the rack a pick was made. In one or more exemplary methods, the handling area identified may refer to an identifier of a storage zone that correspond to a zone in the warehouse where a picker (e.g. a human or a robot) is capable of picking from standard (e.g. non-automated) racks. It is to be noted that an addressing convention for horizontal rack identifier used by the warehouse may be inferred from inspecting the first data or may be provided by the WMS client as an input parameter (i.e. Odd-Even Convention). For example, a common warehouse addressing convention is to have even and odd numbered horizontal rack identifier associated with even and odd numbered rack identifiers, respectively. Obtaining the first data set may be seen as a pre-processing of a Warehouse Management System log data for extraction of relevant pick events.

In one or more exemplary methods, the method 300 comprises obtaining S304 a second data set. The second data set may be indicative of at least one geometric object associated with a layout element of the storage facility (e.g. warehouse). In one or more exemplary methods, a layout element may relate to the layout of the warehouse or storage facility. The layout characterizes a structure and/or one or more architectural elements of the warehouse (e.g. floor structure) and a dimension thereof.

In one or more exemplary methods, a second data set may comprise data indicative of a rack, data indicative of one or more walls, data indicative of one or more machinery-zones and data indicative of one or more office rooms. In one or more exemplary methods, a second data set may comprise one or more polygonal shapefiles associated with a warehouse structure, and/or one or more label associated with a rack and/or a rack identifier.

In one or more exemplary methods, the method 300 comprises generating S306, based on the first data set and the second data set, a spatial location data set indicative of spatial location of the at least one item and the at least one geometric object.

In one or more exemplary methods, a spatial location data set may be a list of item coordinates.

In one or more exemplary methods, the spatial location data set comprises a first spatial location of the first item in a spatial reference system associated with a first-time parameter.

In one or more exemplary methods, the spatial location data set comprises a first spatial location of the first item in a spatial reference system. The spatial reference system may for example be a Cartesian coordinate system.

In one or more exemplary methods, the method 300 comprises generating S308, based on the spatial location data set, a graphical network comprising a set of nodes and a set of edges. A graphical network may refer to a graph (e.g. in graph theory,) which comprises a structure comprising a set of nodes in which some pairs of the nodes are related and where the nodes may be seen as vertices (e.g. points) and each of the related pairs of vertices or related pairs of nodes is called an edge (e.g. an arc or line). In one or more exemplary embodiments, the term “graphical network” is interchangeable with the term “data structure”, the data structure characterizing relations between nodes (e.g. corresponding to elements of the spatial location set).

Generating S308, based on the spatial location data set, the graphical network may comprise generating a data structure characterizing relations between elements of the spatial location set. The data structure may comprise an adjacency matrix characterizing distances (e.g. Euclidean distances) between elements of the spatial location set (e.g. between all elements of the spatial location set). The data structure may comprise an adjacency matrix characterizing distances (e.g. Euclidean distances) between nodes of the graphical network. In one or more exemplary methods, a graphical network may be characterized by an adjacency matrix characterizing distances (e.g. Euclidean distances) between elements of the spatial location set. Generating S308, based on the spatial location data set, the graphical network may comprise generating an adjacency matrix characterizing distances (e.g. Euclidean distances) between elements of the spatial location set.

In one or more exemplary methods, the set of nodes comprises a first node associated with the first item and a depot node. In one or more exemplary methods, a depot node may be indicative of a starting point and/or finish point of a pick run to pick up an item of the picking list. In one or more exemplary methods, the set of nodes comprises a first node associated with the first item, a second node associated with a second item, a depot node and optionally a third node associated with a third item and optionally a Nth node associated with the Nth item (wherein N is an integer).

In one or more exemplary methods, the method 300 comprises obtaining S310 a picking list comprising the first item and the first location code. For example, the picking list may refer to a list of items to be picked up in a picking route and/or a pick run. A pick run may for example refer to a pick route, a pick round, a picking round, an order picking. For example, a picking list is a list that indicates the items to be picked up in a non-ordered manner. Obtaining S310 the picking list may comprise receiving and/or retrieving the picking list. Obtaining S310 the picking list may comprise receiving the picking list in a request (e.g. a WMS request). Obtaining S310 the picking list may comprise receiving the picking list via a user interface of the electronic device.

In one or more exemplary methods, the method 300 comprises determining S312 a route based on the graphical network and the picking list. Determining S312 the route may comprise determining the route based on the picking list and the graphical network using a shortest node-pair path scheme (e.g. Floyd-Warshall scheme) where all the nodes belong to the picking list and applying a route solver scheme (configured to optimize the route according to an objective function minimizing a total route distance). The route determined in S312 may comprise a shortest path to pick up items of the picking list.

In one or more exemplary methods, the method 300 comprises providing S314 a pick sequence based on the determined route. The pick sequence may be seen as a reordered picking list. In one or more exemplary methods, the method may comprise providing S314 a global pick sequence. The global pick sequence may comprise one or more pick sequences for one or more pickers. In other words, the pick sequence may be globally optimized for a set of pickers, such as for all pickers, operating in the storage facility or warehouse.

In one or more exemplary methods, obtaining S304 the second data set comprises obtaining S304A a third data set indicative of the layout element(s); and generating S304B the second data set based on the third data set. For example, the third data set may comprise drawings indicative of the layout element(s) of the storage facility or warehouse (e.g. floor map, CAD drawings), generating S304B the second data set based on the third data set comprises (optionally scaling the drawings and) extracting the second data set from the drawings (optionally scaled). Extracting the second data set may be performed using e.g. scalable vector graphics, SVG, (e.g. .SHP files) shapefile extraction of the warehouse structures.

In one or more exemplary methods, generating S306, based on the first data set and the second data set, the spatial location data set comprises selecting S306A an origin spatial location of the spatial reference system based on the first data set and the second data set. In one or more exemplary methods, generating S306 the spatial location data set may comprise selecting S306A directional information so as to indicate an indexing origin and in which direction an incrementation of the pick points labels occur (e.g. in which direction the horizontal rack ID increments length-wise along a rack). For example, an indexing origin (where location indexing begins) may be specified based on input from the WMS (e.g. situated at the lower wall of the warehouse).

In one or more exemplary methods, generating S306, based on the first data set and the second data set, the spatial location data set comprises obtaining S306B a dimension parameter. For example, a dimension parameter may be one or more sub-rack segment dimensions and/or one or more pallet dimensions. For example, racks may be subdivided into distinct segments that contain varying number of pallets. For example, each pallet represents a distinct location where items are picked. For example, pallets have industry standard dimensions (e.g. EURO pallets have standardized length 1200 mm and width 800 mm).

In one or more exemplary methods, generating S306, based on the first data set and the second data set, the spatial location data set comprises determining S306C the first spatial location associated with the first item based on the dimension parameter (and optionally based on the second data set, e.g. based on a rack identifier associated with the corresponding geometric object). For example, determining S306C comprises identifying one or more rack segment dimensions. For example, using the dimension parameter and a number of items, exact spatial locations can be determined for each location, e.g. picking location, e.g. item location. In one or more exemplary methods, determining S306C the first spatial location comprises determining for each location (e.g. first data set element, e.g. picking location, e.g. item location, e.g. log location tag) a corresponding spatial location.

In one or more exemplary methods, generating S306, based on the first data set and the second data set, the spatial location data set comprises validating S306D the spatial location data set using the first data set. Validating S306D the spatial location data set using the first data set may comprise comparing the spatial location data set to the first data set and determining whether all items identified in the first data set are present in the spatial location data set. The spatial location data set may be larger than the first data set. For example, for each rack (e.g. for a given rack type), it is to be checked that the range of horizontal rack identifier locations given in the first data set does not exceed the range of spatial locations generated to form the spatial location data set.

In one or more exemplary methods, generating S306, based on the first data set and the second data set, the spatial location data set comprises determining S306E, based on the second data set, a further geometric object corresponding to an obstacle in the storage facility or warehouse. Obstacles in the storage facility or warehouse may be defined as obstacles in the storage facility space or the warehouse space, for example corners of racks, walls, machinery.

In one or more exemplary methods, generating S306, based on the first data set and the second data set, the spatial location data set comprises determining S306F an obstacle spatial location associated with the obstacle (e.g. based on the second data set). In one or more exemplary methods, generating S306, based on the first data set and the second data set, the spatial location data set comprises including S306G the obstacle spatial location into the spatial location data set. For example, a Convex hull (e.g. Quickhull, Jarvis) may be used to determine the further geometric object associated with the obstacle, which allows to efficiently navigate around the obstacle. For example, in order to ensure the route is taken around corners of obstacles in the storage facility or warehouse, the corners (vertices) of obstacles (racks, walls machinery etc. . . . ) are included in the spatial location data set so as to be represented by nodes in the graphical network. This may help ensure the route is taken around corners of obstacles in the warehouse.

In one or more exemplary methods, generating S306, based on the first data set and the second data set, the spatial location data set comprises determining S306H, based on the second data set, a further geometric object corresponding to a depot in the storage facility (e.g. in the warehouse). A depot in the storage facility or warehouse may be defined as start and/or finish point of the pick run.

In one or more exemplary methods, generating S306, based on the first data set and the second data set, the spatial location data set comprises determining S306I a depot spatial location associated with the depot (e.g. based on the second data set). In one or more exemplary methods, generating S306, based on the first data set and the second data set, the spatial location data set comprises including S306J the depot spatial location into the spatial location data set. A location of the depot is for example where the picker selects a new pick run and delivers the picked goods for outbound delivery. In some examples, there may exist a plurality of depots. In some examples, determining S306I a depot spatial location associated with the depot may be performed based on input from the warehouse or WMS.

In one or more exemplary methods, generating S308, based on the spatial location data set, the graphical network comprising the set of nodes comprises determining S308A whether edge connectivity between nodes of the graphical network satisfies a disallow criterion; and when the edge connectivity between nodes of the graphical network satisfies the disallow criterion: disallowing S308B the corresponding edges. For example, disallowing S308B the corresponding edges comprises attributing a number 0 to corresponding edges in the adjacency matrix.

In one or more exemplary methods, generating S308, based on the spatial location data set, the graphical network comprising the set of nodes comprises determining S308D an adjacency matrix based on the set of nodes and set of edges.

In one or more exemplary methods, an disallow criterion may comprise a line of sight criterion and/or a narrow path criterion.

Determining S308A whether edge connectivity between nodes of the graphical network satisfies an disallow criterion, wherein the disallow criterion comprises a line of sight criterion, may comprise determining edge connectivity of all node pairs as a line segment connecting two nodes of the pair (e.g. for each polygonal shapefile (including polygonal shapefiles of dummy obstacles)), wherein the line of sight criterion comprises determining whether any part of the line-segment falls within the area enclosed by a polygon associated with the polygonal shapefile (e.g. using a line polygon-intersection scheme), and wherein the disallow criterion is satisfied when any part of the line-segment falls within the area enclosed by a polygon associated with the polygonal shapefile. For example, the disallow criterion is not satisfied when the line segment has not been obstructed by any polygon. This may lead to determining an adjacency matrix with a dimension equal to the dimension K by K where K is the number of nodes in the graphical network (e.g. row and column indices correspond to row indices in a node list so that nodes remain identifiable by index). For example, Boolean values stored in the i-th row for all columns j, corresponds to whether the i-th node (in a node list of the spatial location data set) has a direct connec0tion to all the nodes j in the node list (edge exists=1, edge does not exist/is disallowed=0). For example, the adjacency matrix is symmetrical along the diagonal.

Determining S308A whether edge connectivity between nodes of the graphical network satisfies an disallow criterion, wherein the disallow criterion comprises a narrow path criterion, may comprise determining one or more narrow paths, wherein determining the one or more narrow path comprises determining a distance (e.g. using Edelsbrunner scheme) between a pair of polygons and comparing the distance to a threshold. For example, the narrow path criterion is satisfied when the distance is below the threshold. For example, the narrow path criterion is not satisfied when the distance is equal or above the threshold. For example, disallowing S308B the corresponding edges comprises connecting the corresponding polygons in the second data set to form a new polygon.

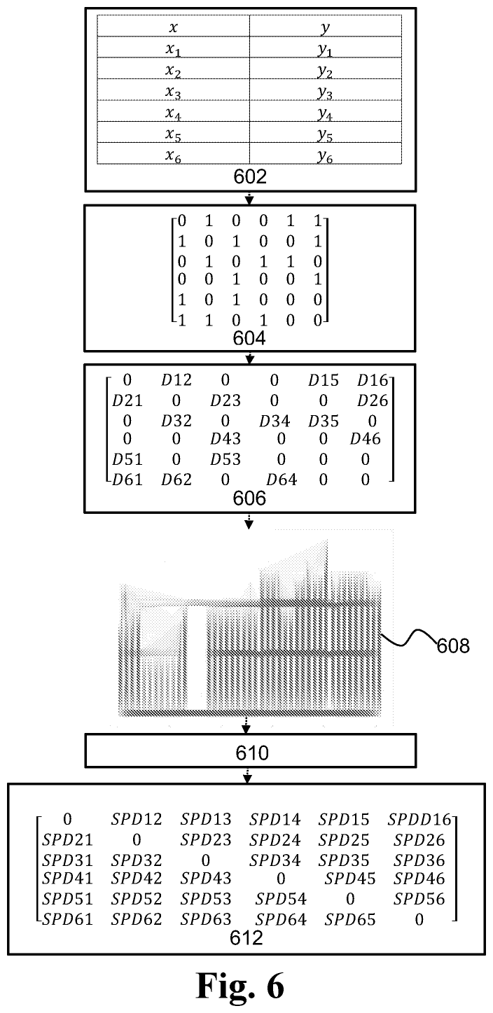

In one or more exemplary methods, generating S308, based on the spatial location data set (e.g. spatial location data set 602 of FIG. 6 listing coordinates of nodes), the graphical network (e.g. graphical network represented by 608 of FIG. 6) comprises determining S308E a weighted adjacency matrix based on the adjacency matrix and distances (e.g. Euclidean distances) between nodes. In order to be able to generate a graphical network (e.g. graphical network represented by 608 of FIG. 6) that allows for shortest path calculation for any two nodes, the adjacency matrix (e.g. an adjacency matrix 604 of FIG. 6) is converted into a weighted adjacency matrix (e.g. weighted adjacency matrix 606 of FIG. 6) wherein a weight is based on a Euclidean distance between two nodes that are directly connected by an edge. The weighted adjacency matrix (e.g. weighted adjacency matrix 606 of FIG. 6) may relate to the adjacency matrix (e.g. an adjacency matrix 604 of FIG. 6) in that where there is a value of 1 for the element at the i-th row and j-th column in the adjacency matrix (e.g. adjacency matrix 604 of FIG. 6), the corresponding value of the element in the weighted adjacency matrix is the distance between node i associated with the first item and node j associated a second item in the spatial reference system.

In one or more exemplary methods, generating S308, based on the spatial location data set, the graphical network (e.g. graphical network represented by 608 of FIG. 6) comprising the set of nodes comprises determining S308E for each pair of nodes a shortest path between two nodes in the pair. Determining S308E for each pair of nodes a shortest path between two nodes in the pair may be performed using a Floyd-Warshall scheme. For example, the Floyd-Warshall scheme takes the graphical network as input and outputs a dictionary data structure (e.g. dictionary data structure 610 of FIG. 6) that can be queried with any two nodes i and j (e.g. ‘from’ and ‘to’ locations, respectively) in the graphical network. For example, when queried, the dictionary returns a sequence of nodes that are to be traversed in order to take the shortest path in the graphical network between the nodes i and j. Determining S308C for each pair of nodes a shortest path between two nodes in the pair may be performed by determining the shortest path distance as e.g. a sum of the Euclidean distances between consecutive nodes that are to be visited in the shortest path. For example, Determining S308C for each pair of nodes a shortest path between two nodes in the pair may comprise storing the shortest path distances in a Shortest Path Distance matrix (e.g. symmetrical along the diagonal, as illustrated in a shortest path distance matrix 612 of FIG. 6) such that for every element at the i-th row and j-th column of the matrix, the distance for the shortest path between nodes i and j is retrievable. This may lead an elimination of redundancy and may allow for an efficient memory-management and computation, and thus an improved (e.g. faster) provision of pick sequence.

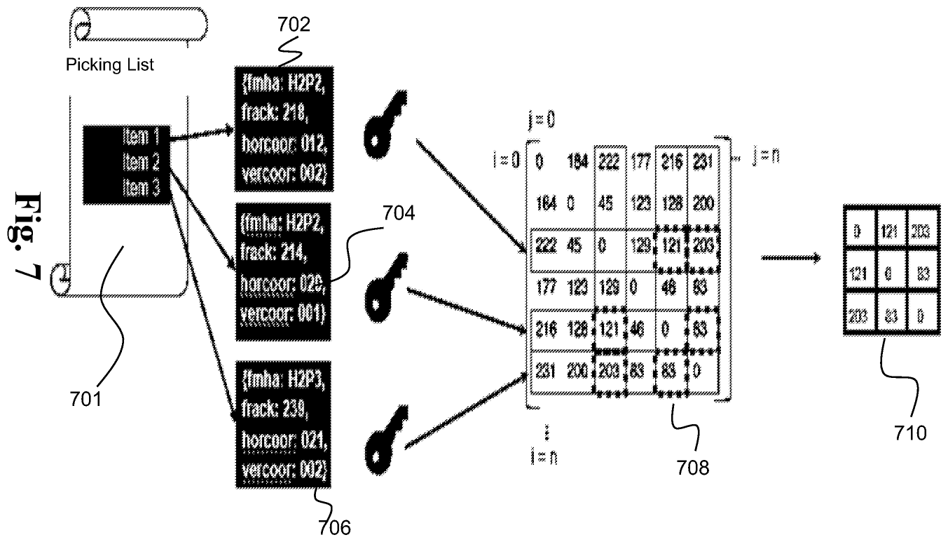

In one or more exemplary methods, determining S312 the route based on the graphical network and the picking list comprises applying S312A a route solving scheme based on an adjacency matrix of the graphical network and the picking list, to minimize a total route distance. According to this disclosure, items in the picking list of items sent by a WMS request may be mapped to nodes in the graphical network, the Subset-Shortest Path Distance matrix for the nodes of interest (e.g. the nodes associated items of the picking list that are to be visited during the pick run and the depot node(s)) may be extracted from the Shortest Path Distance matrix (e.g. a shortest path distance matrix 612 of FIG. 6). The Subset-Shortest Path Distance matrix (e.g. exemplary Subset-Shortest Path Distance matrix 710 of FIG. 7) is provided as input to one of two route solvers performing a route solving scheme by selecting e.g. an Exact Solver and/or an Approximate Solver. An Exact Solver (e.g. Travelling Sale Person solver scheme) is selected when the pick run instance has a problem size that is less than a given threshold (e.g. the threshold is at 100, as computation of problem instances of this size with a Travelling Sale Person solver scheme can find an exact solution within milliseconds). An approximate Solver (e.g. Simulated Annealing) is selected when the instance is larger than a predefined threshold. For example, the selected route solver then optimizes the route according to an objective function minimizing total route distance. For example, the route solver then returns a reordered list specifying the optimal sequence of nodes (sequence of locations for the picker to visit), starting and ending at the depot.

In one or more exemplary methods, providing S314 the pick sequence based on the determined route comprises providing S314A the pick sequence in real-time. For example, a live route optimization may be performed by the disclosed methods and provide the resulting pick sequence in real-time (e.g. quasi real time) to a requester.

FIG. 4 shows a block diagram of an exemplary electronic device 400 according to the disclosure. The present disclosure related to an electronic device 400 comprising a memory module 402, an interface module 401, and a processor module 403. In one or more exemplary methods, the electronic device 400 is configured to perform any of the steps of the methods disclosed in FIGS. 3A-3B.

The electronic device 400 is configured to obtain, e.g. via the processor module 403 (e.g. via an obtainer module 403A) a first data set e.g. from a warehouse management system, wherein the first data set is indicative of at least one item of the items stored in the storage facility or warehouse, and the first data set comprises a first location code associated with a first item.

The electronic device 400 is configured to obtain, e.g. via the processor module 403 (e.g. via an obtainer module 403A) a second data set, wherein the second data set is indicative of at least one geometric object associated with a layout element of the warehouse.

The electronic device 400 may be configured to generate, e.g. via the processor module 403 (e.g. via a spatial generator module 403B), based on the first data set and the second data set, a spatial location data set indicative of spatial location of the at least one item and the at least one geometric object, wherein the spatial location data set comprises a first spatial location of the first item in a spatial reference system.

The electronic device 400 may be configured to generate, e.g. via the processor module 403 (e.g. via a graph generator module 403C), based on the spatial location data set, a graphical network comprising a set of nodes and a set of edges, wherein the set of nodes comprises a first node associated with the first item and a depot node.

The electronic device 400 is configured to obtain, e.g. via the processor module 403 (e.g. via the obtainer module 403A) a picking list comprising the first item and the first location code.

The electronic device 400 is configured to determine, e.g. via the processor module 403 (e.g. via a determiner module 403D) a route based on the graphical network and the picking list.

The electronic device 400 may be configured to provide, e.g. via the processor module 403 (e.g. via a provision module 403E) a pick sequence based on the determined route.

The electronic device 400 may be configured to perform any of the methods disclosed in FIGS. 3A-3C.

The electronic device 400 may be configured to communicate, via the interface module 401, with a WMS system (e.g. system 100 of FIG. 1) and optionally with a client device (e.g. picker device 200 of FIG. 1) so as to provide real-time pick sequence(s). The interface module 401 may be configured for wired and/or a wireless communication.

The processor module 403 is optionally configured to perform any of the operations disclosed in FIG. 3A-3B. The operations of the electronic device 400 may be embodied in the form of executable logic routines (e.g., lines of code, software programs, etc.) that are stored on a non-transitory computer readable medium (e.g., the memory module 402) and are executed by the processor module 403).

Also, while the described functions and operations may be implemented in software, such functionality may as well be carried out via dedicated hardware or firmware, or some combination of hardware, firmware and/or software.

The memory module 402 may be one or more of a buffer, a flash memory, a hard drive, a removable media, a volatile memory, a non-volatile memory, a random access memory (RAM), or other suitable device. In a typical arrangement, the memory module 402 may include a non-volatile memory for long term data storage and a volatile memory that functions as system memory for the processor module 403. The memory module 402 may exchange data with the processor module 403 over a data bus. Control lines and an address bus between the memory module 402 and the processor module 403 also may be present (not shown in FIG. 4). The memory module 402 is considered a non-transitory computer readable medium.

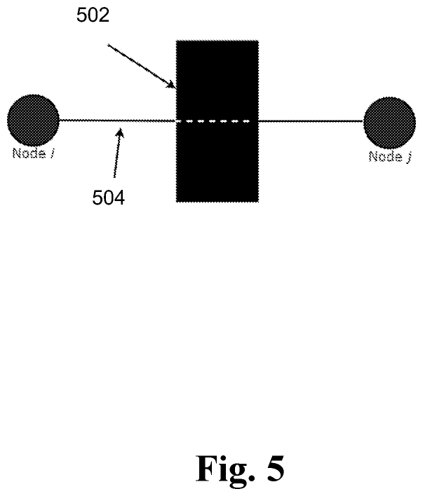

FIG. 5 is a diagram illustrating an exemplary disallowing operation according to this disclosure.

The disclosed method may comprise determining whether edge connectivity between nodes of the graphical network satisfies an disallow criterion. In FIG. 5, the disallow criterion is a line of sight criterion.

For example, determining whether edge connectivity between nodes (i,j) of the graphical network satisfies comprise determining edge connectivity of all node pairs as a line-segment 504 connecting two nodes (i,j) of the pair (e.g. for each polygonal shapefile (including polygonal shapefiles of dummy obstacles)). In FIG. 5, it is shown that the line of sight criterion comprises determining whether any part of the line-segment 504 falls within the area enclosed by a polygon 502 associated with the polygonal shapefile. The disallow criterion is satisfied when any part of the line-segment 504 falls within the area enclosed by a polygon 502 associated with the polygonal shapefile. For example, the disallow criterion is not satisfied when the line segment 504 has not been obstructed by any polygon.

This may lead to determining an adjacency matrix with a dimension equal to the dimension K by K where K is the number of nodes in the graphical network (e.g. row and column indices correspond to row indices in a node list so that nodes remain identifiable by index). For example, Boolean values stored in the i-th row for all columns j, corresponds to whether the i-th node (in a node list of the spatial location data set) has a direct connection to all the nodes j in the node list (edge exists=1, edge does not exist or is obstructed=0). For example, the adjacency matrix is symmetrical along the diagonal.

FIG. 6 is a diagram illustrating an exemplary spatial location data set 602, an exemplary adjacency matrix 604, an exemplary weighted adjacency matrix 606, an exemplary representation 608 of an exemplary graphical network, an exemplary shortest path dictionary data structure 610, and an exemplary shortest path distance matrix 612 according to this disclosure.

The spatial location data set 602 is in the form a node coordinate list comprising coordinates (x1,y1) for a first node, (x2,y2) for a second node, etc.

The adjacency matrix 606 has a dimension equal to the dimension K by K where K=6 nodes in the graphical network (e.g. row and column indices correspond to row indices in a node list e.g. 604 so that nodes remain identifiable by index). For example, Boolean values stored in the i-th row for all columns j, corresponds to whether the i-th node (in a node list of the spatial location data set) has a direct connection to all the nodes j in the node list (edge exists=1, edge does not exist or is obstructed=0). For example, the adjacency matrix 606 is symmetrical along the diagonal.

The weighted adjacency matrix 606 is determined based on the adjacency matrix 604 and a distance parameter between any two nodes. Where there is a value of 1 for the element at the i-th row and j-th column in the adjacency matrix 604, the corresponding value of the exemplary element (1,2) in the weighted adjacency matrix 606 is the distance D12 between node 1 associated with the first item and node 2 associated a second item in the spatial reference system.

Determining for each pair of nodes a shortest path between two nodes in the pair may be performed using a Floyd-Warshall scheme. For example, the Floyd-Warshall scheme takes the graphical network represented by 608 as input and outputs a dictionary data structure 610 that can be queried with any two nodes i and j (e.g. ‘from’ and ‘to’ locations, respectively) in the graphical network represented by 608. For example, when queried, the dictionary returns a sequence of nodes that are to be traversed in order to take the shortest path in the graphical network represented by 608 between the nodes i and j. Determining for each pair of nodes a shortest path between two nodes in the pair may be performed by determining the shortest path distance as e.g. a sum of the Euclidean distances between consecutive nodes that are to be visited in the shortest path. For example, determining for each pair of nodes a shortest path between two nodes in the pair may comprise storing the shortest path distances in a Shortest Path Distance matrix 612 (e.g. symmetrical along the diagonal) such that for every element SPDij at the i-th row and j-th column of the matrix, the distance for the shortest path between nodes i and j is retrievable.

FIG. 7 illustrates in graphical representations an exemplary picking list 702, an exemplary first data set comprising a first location code 702, a second location 704, a third location code 706.

FIG. 7 shows an exemplary shortest path distance matrix 708, and an exemplary subset-shortest path distance matrix 710 according to this disclosure.

In an example where the present technique is applied, when a request is made (by the WMS) for a pick run route to be optimized based on a picking list 701, the WMS provides a list of items (with location code of the first data set, e.g. the first location code 702, the second location 704, and the third location code 706) as input to the disclosed electronic device (e.g. in step S310). The list of items may be first checked to see if any of the items belong to locations in the warehouse that are not mapped in the graphical network (when any item locations are not mapped, then the route for this pick run cannot be optimized). The check may be done through the use of a dictionary data structure (e.g. a dictionary data structure 610 of FIG. 6) that maps distinct ‘keys’ (as illustrated in FIG. 7, each key is the String concatenation of WMS item location labels: MHA, Rack ID, Horizontal Rack Location ID) to the distinct row index of nodes in the Node List and row/column index in the Shortest Path Distance Matrix 708.

Items in the picking list 701 sent by a WMS request may be mapped to nodes of the graphical network. A Subset-Shortest Path Distance matrix 710 for the nodes of interest (e.g. the nodes associated items of the picking list that are to be visited during the pick run and the depot node(s)) may be extracted from the Shortest Path Distance matrix 708. The Subset-Shortest Path Distance matrix 708 is provided as input to a route solving scheme.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-7 comprises some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

1. A method, performed at an electronic device, for controlling a management system configured to manage items stored in a storage facility, the method comprising:
obtaining a first data set, wherein the first data set is indicative of at least one item of the items, and wherein the first data set comprises a first location code associated with a first item;
obtaining a second data set, wherein the second data set is indicative of at least one geometric object associated with a layout element of the storage facility;
generating, based on the first data set and the second data set, a spatial location data set indicative of spatial location of the at least one item and the at least one geometric object, wherein the spatial location data set comprises a first spatial location of the first item in a spatial reference system;
generating, based on the spatial location data set, a graphical network comprising a set of nodes and a set of edges, wherein the set of nodes comprises a first node associated with the first item and a depot node;
obtaining a picking list comprising the first item and the first location code;
determining a route based on the graphical network and the picking list; and
providing a pick sequence based on the determined route.

2. The method according to claim 1, wherein obtaining the second data set comprises obtaining a third data set indicative of the layout element;
and generating the second data set based on the third data set.

3. The method according to claim 1, wherein generating, based on the first data set and the second data set, the spatial location data set comprises selecting an origin spatial location of the spatial reference system based on the first data set and the second data set.

4. The method according to claim 1, wherein generating, based on the first data set and the second data set, the spatial location data set comprises:
obtaining a dimension parameter; and
determining the first spatial location based on the dimension parameter.

5. The method according to claim 1, wherein generating, based on the first data set and the second data set, the spatial location data set comprises validating the spatial location data set using the first data set.

6. The method according to claim 1, wherein generating, based on the first data set and the second data set, the spatial location data set comprises:
determining, based on the second data set, a further geometric object corresponding to an obstacle in the storage facility;
determining an obstacle spatial location associated with the obstacle; and
including the obstacle spatial location into the spatial location data set.

7. The method according to claim 1, wherein generating, based on the first data set and the second data set, the spatial location data set comprises:
determining, based on the second data set, a further geometric object corresponding to a depot in the storage facility;
determining a depot spatial location associated with the depot; and
including the depot spatial location into the spatial location data set.

8. The method according to claim 1, wherein generating, based on the spatial location data set, the graphical network comprising the set of nodes comprises:
determining whether edge connectivity between nodes of the graphical network satisfies a disallow criterion; and when edge connectivity between nodes of the graphical network satisfies the disallow criterion:
disallowing the corresponding edges.

9. The method according to claim 1, wherein determining, the route based on the graphical network and the picking list comprises applying, a route solving scheme based on an adjacency matrix of the graphical network and the picking list, to minimize a total route distance.

10. The method according to claim 1, wherein providing, the pick sequence based on the determined route comprises providing the pick sequence in real-time.

11. The method according to claim 9, wherein the adjacency matrix comprises distances between elements of the spatial location data set.

12. The method according to claim 8, wherein determining whether edge connectivity between nodes of the graphical network satisfies an disallow criterion comprises determining one or more narrow paths, wherein the disallow criterion comprises a narrow path criterion.

13. The method according to claim 12, wherein determining the one or more narrow path comprises determining a distance between a pair of polygons and comparing the distance to a threshold.

14. The method according to claim 1, wherein generating, S308, based on the spatial location data set, the graphical network comprises determining S308E a weighted adjacency matrix based on the adjacency matrix and distances between nodes.

15. An electronic device comprising a memory module an interface module, and a processor module, wherein the electronic device is configured to:
obtain a first data set, wherein the first data set is indicative of at least one item of the items, and wherein the first data set comprises a first location code associated with a first item;
obtain a second data set, wherein the second data set is indicative of at least one geometric object associated with a layout element of the storage facility;
generate, based on the first data set and the second data set, a spatial location data set indicative of spatial location of the at least one item and the at least one geometric object, wherein the spatial location data set comprises a first spatial location of the first item in a spatial reference system;
generate, based on the spatial location data set, a graphical network comprising a set of nodes and a set of edges, wherein the set of nodes comprises a first node associated with the first item and a depot node;
obtain a picking list comprising the first item and the first location code;
determine a route based on the graphical network and the picking list; and
provide a pick sequence based on the determined route.
